(19) United States
(12) Patent Application Publication
(10) Pub. No.: US 2016/0014520 A1
(43) Pub. Date: Jan. 14, 2016

(54) SPEAKER DIAPHRAGM

(71) Applicants: PIONEER CORPORATION, Kawasaki-shi, Kanagawa (JP); MOGAMI DENKI CORPORATION, Mogami-gun, Yamagata (JP)

(72) Inventors: Yuichi MIURA, Yamagata (JP); Teizo OBA, Yamagata (JP)

(73) Assignees: MOGAMI DENKI CORPORATION, Mogami-gun, Yamagata (JP); PIONEER CORPORATION, Kawasaki-shi, Kanagawa (JP)

(21) Appl. No.: 14/771,104

(22) PCT Filed: Feb. 28, 2013
(86) PCT No.: PCT/JP2013/055409

§ 371 Date: Aug. 27, 2015

(51) Int. Cl. H04R 7/12

(52) U.S. Cl. CPC H04R 7/122

(57) ABSTRACT

Provided is an inexpensive speaker diaphragm which can suppress inter-layer peeling. A speaker diaphragm includes a first diaphragm layer and a second diaphragm layer which are respectively configured by sheet-forming bodies of materials and stacked to each other, and the first diaphragm layer and the second diaphragm layer are integrally formed in a boundary portion.

### TECHNICAL FIELD

The present invention relates to a speaker diaphragm.

### BACKGROUND ART

As a speaker diaphragm, there is disclosed a speaker diaphragm having a multi-layered structure in which a plurality of diaphragm layers different in physical properties are overlapped for the purpose of improvement in sound quality (for example, see Patent Literature 1). The speaker diaphragm having such a multi-layered structure is manufactured such that after materials different from each other are sheet-formed, inner-layer corn paper which is sheet-formed and in the semi-dry condition is stacked and held between inner corn paper and outer corn paper which are sheet-formed and in a semi-dry condition, and then heated and pressed, or an adhesive fiber is employed as a material of one layer to be bonded with the other layer.

### CITATION LIST

### Patent Literature

Patent Literature 1: JP H03-210897 A

### SUMMARY OF INVENTION

### Technical Problem

However, in the speaker diaphragm manufactured as described above, the respective layers previously sheet-formed are dewatered and overlapped, so that the combining between the respective corn papers (the respective layers) is relatively week, and a defect such as inter-layer peeling may occur. In addition, the employment of the adhesive fiber may cause an increase of costs for the manufacturing.

Herein, an object of the present invention is to provide an inexpensive speaker diaphragm which can suppress the inter-layer peeling.

### Solution to Problem

In order to solve the above problem, according to the first aspect of the present invention, there is provided a speaker diaphragm which includes a plurality of stacked sheet-forming bodies in which adjacent two sheet-forming bodies are integrated.

### BRIEF DESCRIPTION OF DRAWINGS

FIGS. 1A to 1C are diagrams for describing a speaker diaphragm according to an embodiment of the present invention, in which FIG. 1A is a half cross-sectional view for describing a speaker device in which the speaker diaphragm according to an embodiment of the present invention is employed, FIG. 1B is a cross-sectional view for describing the speaker diaphragm illustrated in FIG. 1A, and FIG. 1C is an enlarged cross-sectional view of the speaker diaphragm illustrated in FIG. 1B.

FIG. 2 is a diagram for describing a manufacturing apparatus of the speaker diaphragm, and a diagram for describing an example of a first diaphragm layer forming process of a manufacturing method of the speaker diaphragm.

FIG. 3 is a diagram for describing an example of a liquid layer injection process of the manufacturing method of the speaker diaphragm.

FIG. 4 is a diagram for describing an example of a second diaphragm layer forming process of the manufacturing method of the speaker diaphragm.

FIG. 5 is a diagram for describing an example of a state where a suspension containing a material of a second diaphragm layer is injected and deposited.

FIG. 6 is a diagram for describing an example of a forming process of the manufacturing method of the speaker diaphragm.

FIG. 7 is a diagram for describing an example of another forming process of the manufacturing method of the speaker diaphragm.

FIGS. 8A and 8B are diagrams for describing a configuration of a modified example of a speaker diaphragm according to an embodiment of the present invention, in which FIG. 8A is a cross-sectional view for describing the speaker diaphragm, and FIG. 8B is an enlarged cross-sectional view of the speaker diaphragm illustrated in FIG. 8A.

FIG. 9 is a diagram for describing a configuration of a modified example of the manufacturing apparatus of the speaker diaphragm illustrated in FIG. 2.

FIG. 10 is a diagram for describing a configuration of another modified example of the manufacturing apparatus of the speaker diaphragm illustrated in FIG. 2.

### DESCRIPTION OF EMBODIMENTS

Hereinafter, a speaker diaphragm according to an embodiment of the present invention will be described.

The speaker diaphragm according to an embodiment of the present invention is provided with a plurality of sheet-forming bodies which are stacked, and two sheet-forming bodies adjacent to each other are integrated. In addition, a boundary portion between two sheet-forming bodies adjacent to each other may be integrated. With this configuration, the sheet-forming bodies can be strongly integrated without using an adhesive fiber or the like, and an interlayer separation can be suppressed at a low cost. In addition, the connectivity between the sheet-forming bodies can be increased. The integrity includes the connectivity. As a specific example of the integrity, a predetermined close contact force, a predetermined adhesive force,a predetermined peeling strength,a predetermined bonding force, and a predetermined binding force may be exemplified.

In addition, the sheet-forming body may be configured by materials, and the materials of the two sheet-forming bodies may be entangled to form an entangled portion in the boundary portion between two sheet-forming bodies. With this configuration, two sheet-forming bodies adjacent to each other are integrated by the entangled portion in the boundary portion, and the integrity between the sheet-forming bodies is increased, so that the separation between the sheet-forming bodies can be suppressed. In addition, it is possible to increase the integrity between the respective sheet-forming bodies.

In addition, a thickness of the entangled portion may be smaller than that of one sheet-forming in the two sheet-forming bodies. With this configuration, the integrity between the respective sheet-forming bodies is increased, so that the separation between the sheet-forming bodies can be suppressed. In addition, while keeping a predetermined thickness of the respective sheet-forming bodies, the integrity between the respective sheet-forming bodies is increased, so that the separation between the sheet-forming bodies can be suppressed. In addition, since the predetermined thickness of the respective sheet-forming bodies can be kept, it is possible to improve an acoustic characteristic of a speaker device in which the speaker diaphragm according to the present invention is used.

In addition, the two sheet-forming bodies adjacent to each other may have a peeling strength therebetween. With this configuration, the integrity between the respective layers is increased, so that the separation between the sheet-forming bodies can be suppressed.

In addition, a density of one sheet-forming body in the two sheet-forming bodies may be larger than that of the other sheet-forming body. In addition, a Young's modulus of one sheet-forming body in the two sheet-forming bodies maybe larger than that of the other sheet-forming body. With such a configuration, the Young's modulus of the speaker diaphragm is increased, and the acoustic characteristic of the speaker device using the speaker diaphragm can be improved.

In addition, one sheet-forming body of the two sheet-forming bodies adjacent to each other is a surface layer among a plurality of sheet-forming bodies, and the one sheet-forming body may have a uniform thickness over the entire area. With this configuration, the acoustic characteristic of the speaker device using the speaker diaphragm can be improved.

In addition, one sheet-forming body adjacent to the other sheet-forming body of the two sheet-forming bodies adjacent to each other may be formed to have a uniform thickness over the entire area. With this configuration, the acoustic characteristic of the speaker device using the speaker diaphragm can be improved.

### Embodiments

Hereinafter, a speaker diaphragm according to an embodiment of the present invention, and a manufacturing apparatus and a manufacturing method of the speaker diaphragm will be described with reference to the drawings.

First, the configuration of the speaker diaphragm will be described, and then the manufacturing apparatus and the manufacturing method of a manufacturing plate for the speaker will be described.

### (Embodiment of Speaker Diaphragm)

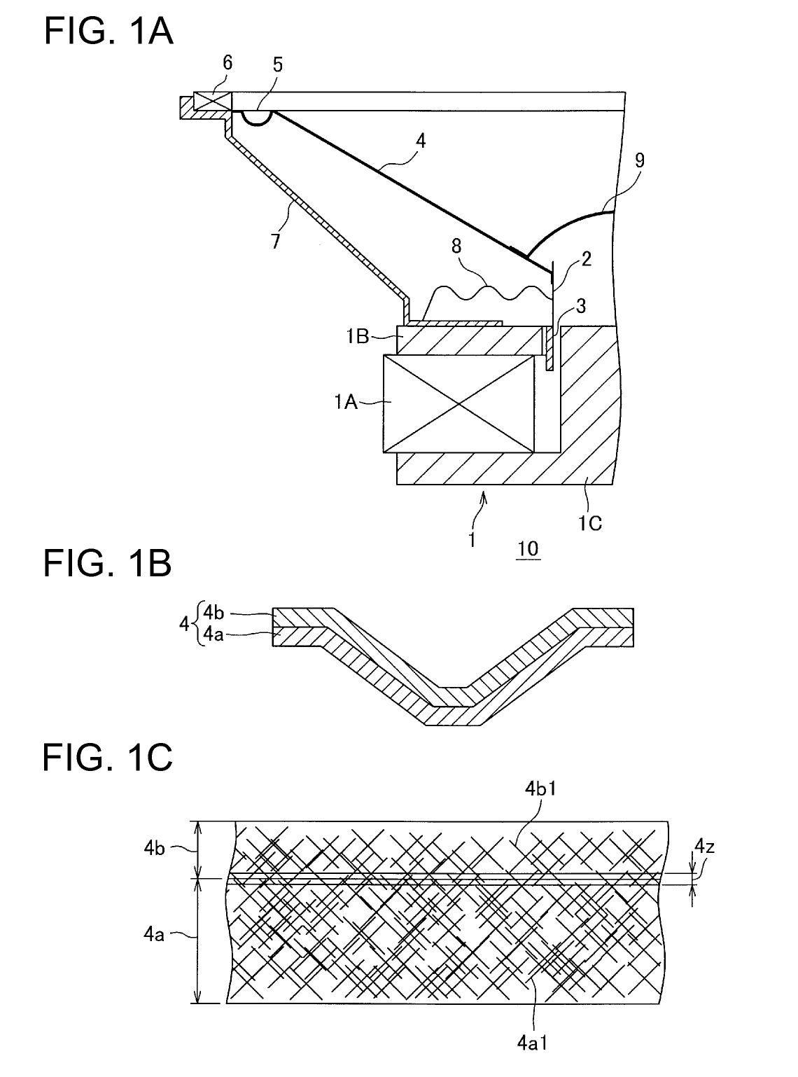

Hereinafter, the speaker diaphragm will be described with reference to FIGS. 1A to 1C.

FIGS. 1A to 1C are diagrams for describing the speaker diaphragm according to an embodiment of the present invention. FIG. 1A is a half cross-sectional view for describing the speaker device in which the speaker diaphragm according to the embodiment of the present invention is employed. FIG. 1B is a cross-sectional view for describing the speaker diaphragm illustrated in FIG. 1A. FIG. 1C is an enlarged cross-sectional view of the speaker diaphragm illustrated in FIG. 1B.

As illustrated in FIG. 1A, a speaker device 10 employing the speaker diaphragm according to the embodiment of the present invention includes a magnetic circuit 1 formed of a magnet 1A, a plate 1B, and a yoke 1C, a voice coil 3 which is disposed in a magnetic gap of the magnetic circuit 1 and wounded around a voice coil supporting portion 2, and a speaker diaphragm 4 of which the center portion is fixed to the voice coil supporting portion 2. The outer peripheral edge of the speaker diaphragm 4 is fixed to a frame 7 through an edge 5 and a gasket 6. The voice coil supporting portion 2 is fixed to the frame 7 by a damper 8, and an opening of the voice coil supporting portion 2 is covered by a center cap 9.

The speaker diaphragm 4 has a multi-layered structure in which a plurality of diaphragm layers is stacked. As illustrated in FIGS. 1B and 1C, the speaker diaphragm 4 includes a first diaphragm layer 4a and a second diaphragm layer 4b which are configured by the sheet-forming body formed by a sheet-forming process. The speaker diaphragm 4 is an example of a stack, and an example of a multi-layered sheet-forming body. The first diaphragm layer 4a and the second diaphragm layer 4b each correspond to an example of the sheet-forming body. Herein, the description will be made about the two-layered speaker diaphragm 4, but the present invention is not limited thereto. The speaker diaphragm 4 may have a multi-layered structure containing three or more layers. In addition, the configuration of the speaker diaphragm described below may be diverted to be used as a speaker edge, the speaker diaphragm body formed by integrating the speaker diaphragm and the speaker edge, or the center cap. In this case, the speaker edge has a multi-layered structure in which a plurality of edge layers are stacked, the speaker diaphragm body includes a multi-layered structure in which a plurality of diaphragm layers are stacked, and the center cap includes a multi-layered structure in which a plurality of center cap layers are stacked.

In the plurality of diaphragm layers included in the speaker diaphragm 4, the outermost layer where the center cap 9 is provided corresponds to an example of the surface layer. The first diaphragm layer 4a corresponds to an example of the other layer, and the second diaphragm layer 4b corresponds to an example of one layer and the surface layer.

Each diaphragm layer of the speaker diaphragm 4 is configured by a material. For example, the material includes a fibrous material such as a wood pulp fiber, a non-wood pulp fiber, a chemical fiber, a synthetic fiber, an animal fiber, a plant fiber, an organic fiber, an inorganic fiber, a glass fiber, a carbon fiber, or a ceramic fiber, and a granular material such as mica powder, graphite, a carbon-based material, a metal material, a ceramic material, or a resin. Further, the “material”, for example, includes powder, hollow particles, fibers, or the like. A material 4a1 of the first diaphragm layer 4a and a material 4b1 of the second diaphragm layer 4b may be different in type, or may be the same in type.

A liquid layer containing no material of the diaphragm layer is interposed between the diaphragm layers of the speaker diaphragm 4 as described below, and a suspension containing the material of the diaphragm layer is sequentially sheet-formed to stack a plurality of diaphragm layers, and the diaphragm layers are integrated. At this time, the materials of the adjacent two diaphragm layers are bonded to each other through a chemical bonding (herein, the “chemical bonding” includes Van der Waals force, hydrogen bonding, metallic bonding, or the like). In particular, in a case where the materials are natural fibers, the materials are bonded through the hydrogen bonding. The suspension corresponds to an example of a first liquid and a second liquid. The speaker diaphragm 4 of such a configuration has a relative large bonding force between the diaphragm layers, so that a defect such as an inter-layer peeling can be prevented. In addition, in the speaker diaphragm 4 having a stacked structure by the sheet-forming, there is formed an entangled portion 4z in which the fibrous materials (in particular, the fibers) of the diaphragm layers are entangled in the boundary portion between the diaphragm layers. The diaphragm layers are integrally configured by the entangled portion 4z so as to make the integration (including a bonding force) between the diaphragm layers increased, so that the defect such as the inter-layer peeling can be suppressed.

It is desirable that a thickness of the entangled portion 4z formed in the boundary portion between the first diaphragm layer 4a and the second diaphragm layer 4b of the speaker diaphragm 4 be small with respect to the thickness of the first diaphragm layer 4a or the thickness of the second diaphragm layer 4b in order to make the first diaphragm layer 4a and the second diaphragm layer 4b have a predetermined thickness.

### (Exemplary Configuration of Manufacturing Apparatus and Manufacturing Method of Speaker Diaphragm)

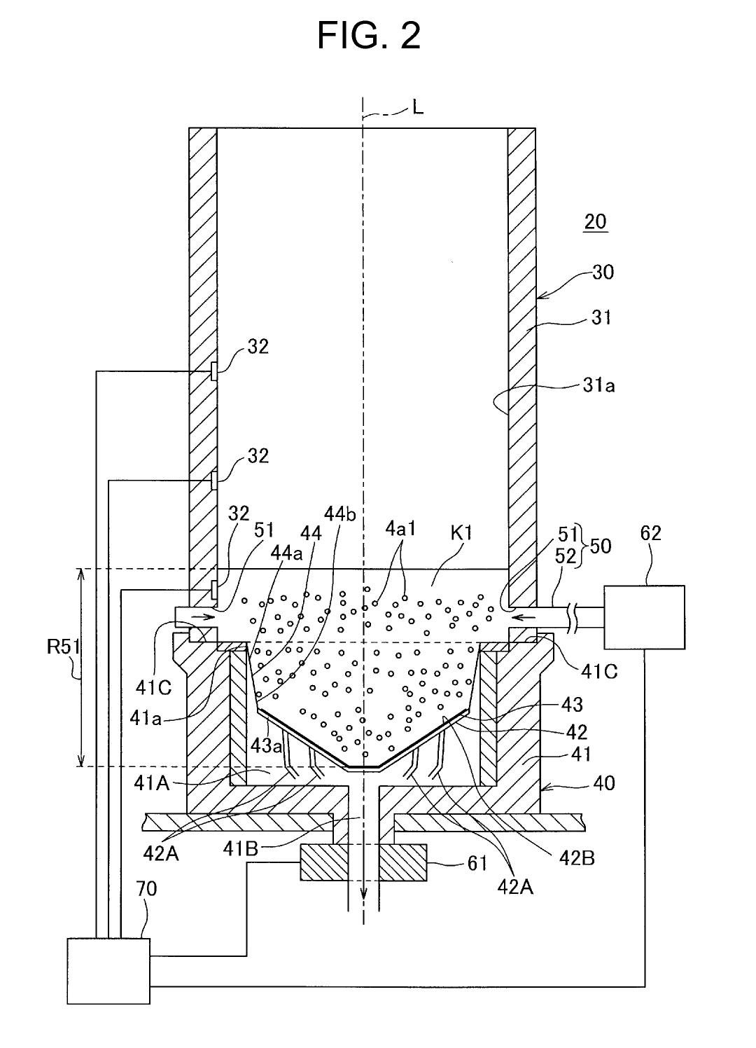

Hereinafter, an example of the manufacturing apparatus and the manufacturing method used in manufacturing the speaker diaphragm according to an embodiment of the present invention will be described with respect to FIGS. 2 to 7.

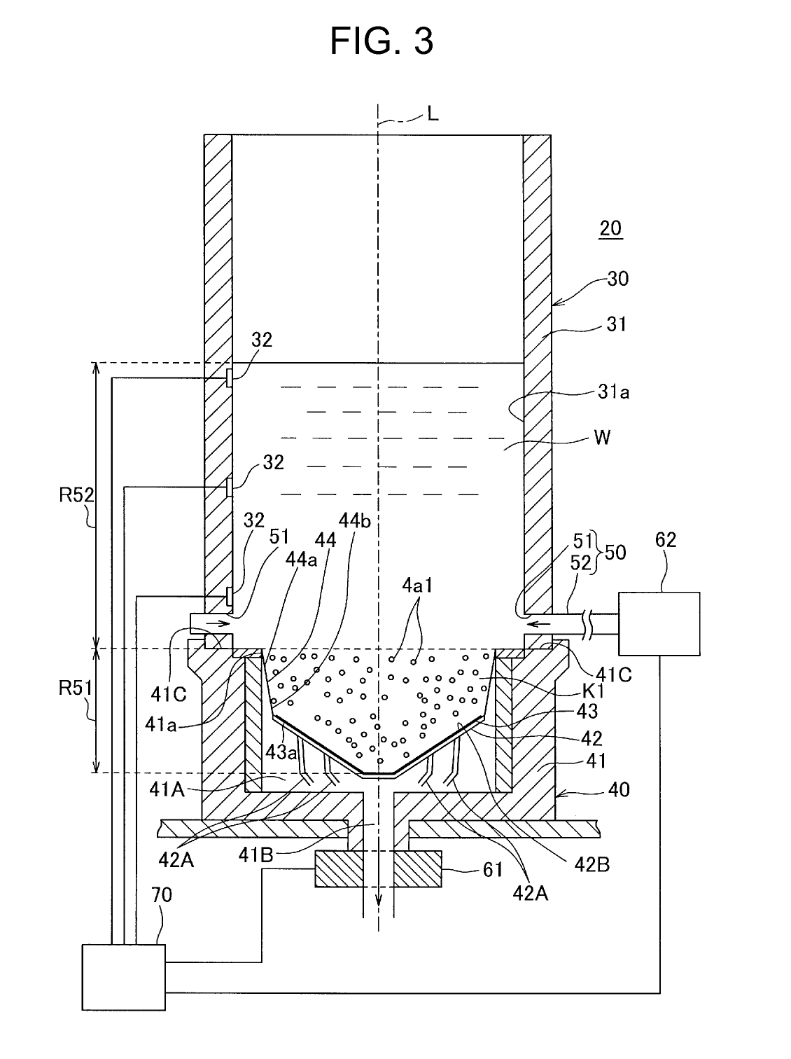

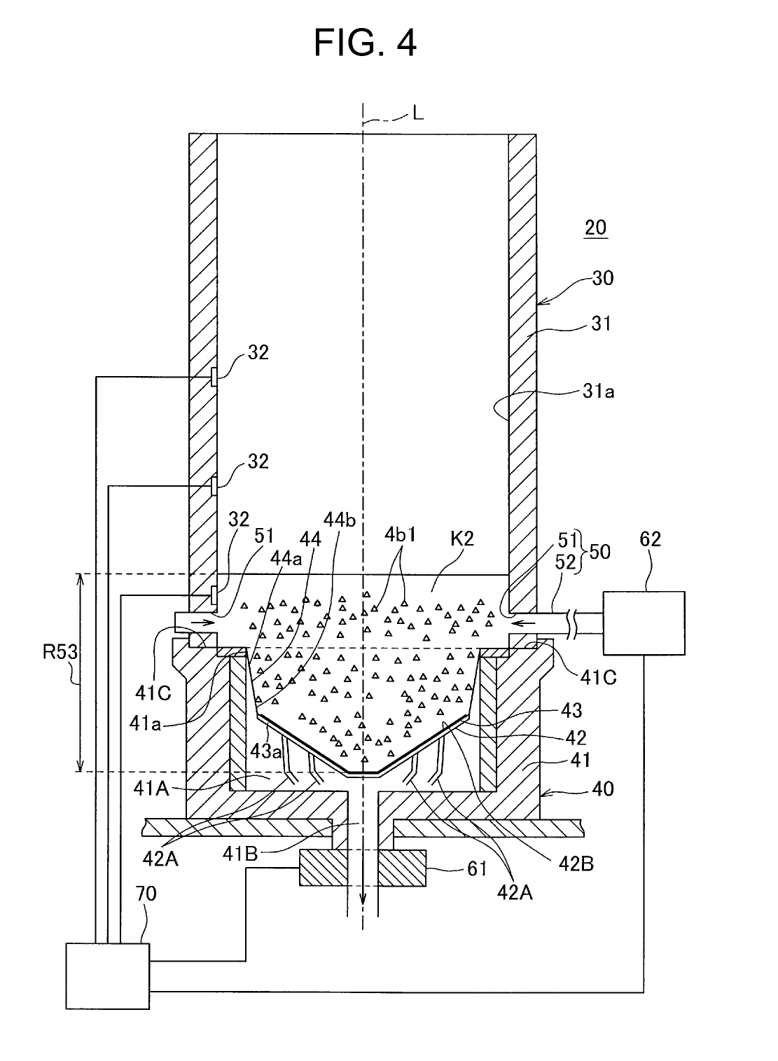

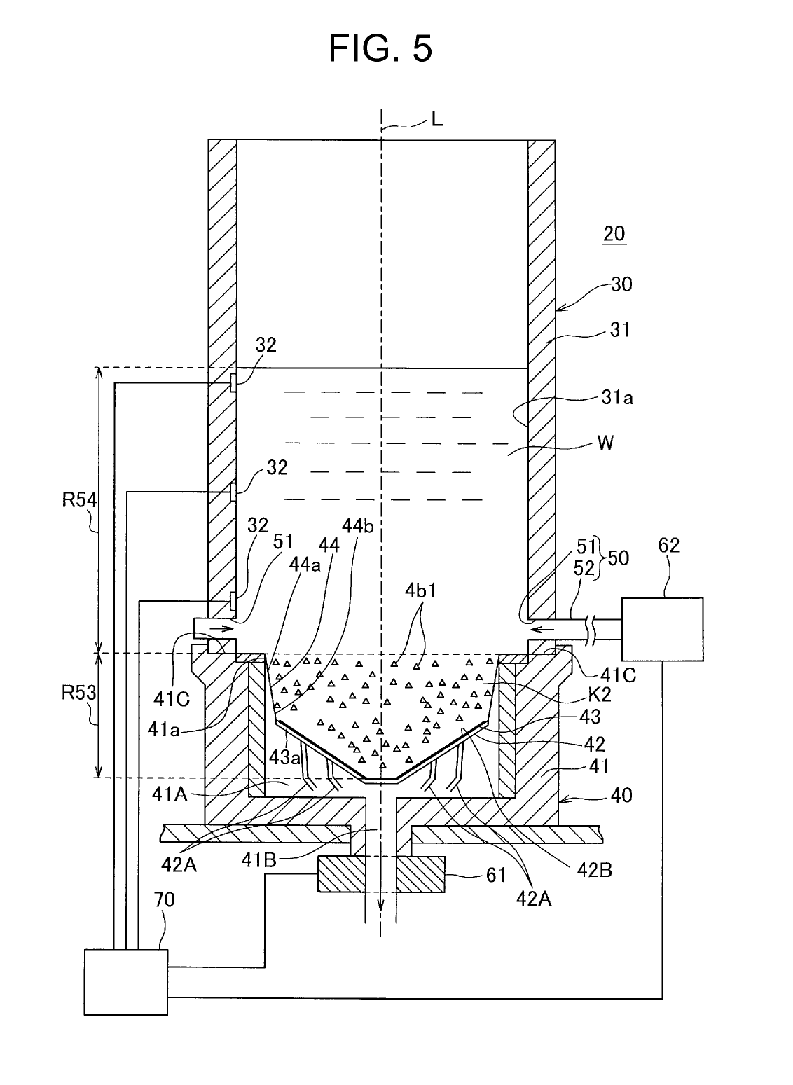

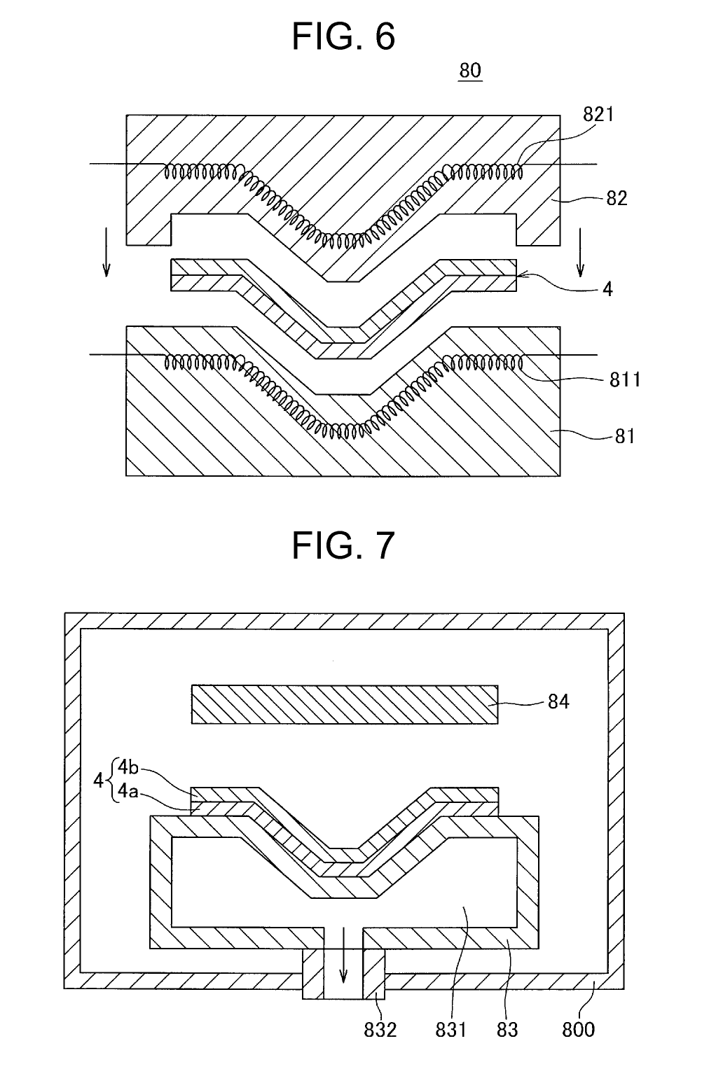

FIG. 2 is a diagram for describing the manufacturing apparatus of the speaker diaphragm, and a diagram for describing an example of a first diaphragm layer forming process of the manufacturing method of the speaker diaphragm. FIG. 3 is a diagram for describing an example of a liquid layer injection process of the manufacturing method of the speaker diaphragm. FIG. 4 is a diagram for describing an example of a second diaphragm layer forming process of the manufacturing method of the speaker diaphragm. FIG. 5 is a diagram for describing an example of a state where a suspension containing a material of the second diaphragm layer is injected and deposited. FIG. 6 is a diagram for describing an example of a forming process of the manufacturing method of the speaker diaphragm. FIG. 7 is a diagram for describing an example of another forming process of the manufacturing method of the speaker diaphragm.

A manufacturing apparatus 20 of the speaker diaphragm sequentially injects the suspensions containing the material of the diaphragm layer while interposing a liquid layer containing no material of the diaphragm layer therebetween into a common tank for the sheet-forming, and sequentially sheet-forms the suspension to stack a plurality of diaphragm layers. The manufacturing apparatus 20 of the speaker diaphragm corresponds to an example of a laminate manufacturing apparatus.

As illustrated in FIG. 2, the manufacturing apparatus 20 of the speaker diaphragm includes a tank 30, a dewatering device 61, a liquid injection device 62, and a controller 70.

The tank 30 includes a tank body 31, a sheet-forming portion 40, and a liquid injection portion 50.

The tank body 31, for example, is formed in a barrel shape (a cylindrical shape in the illustrated example) using a light transmitting material such as acryl, and a liquid such as water or a liquid such as the suspension containing the material of the diaphragm is injected to the inside thereof. In other words, the tank body 31 contains the liquid. The tank body 31 corresponds to an example of a wall (in the illustrated example, the wall is formed in a barrel shape) of the tank.

The sheet-forming portion 40 includes a mounting portion 41, a mold 42, a net 43, and a slope portion 44. The mounting portion 41 is formed in a concave shape, and the mold 42, the net 43, and the slope portion 44 are disposed in the mounting portion 41. In the center of the bottom of the mounting portion 41, a connection port 41B is provided as an example of a drain port to which the dewatering device 61 described below is connected, and a valve is provided in the connection port 41B. The mold 42 includes a plurality of suction ports 42A and a support surface 42B to which the plurality of suction ports 42A are attached and the net 43 is supported. The plurality of suction ports 42A is connected to the dewatering device 61. The support surface 42B is formed in a concave shape, and the net 43 is disposed on the support surface 42B. The slope portion 44 is connected to an outer peripheral portion 43a of the net 43.

The net 43, for example, is formed in a shape previously defined according to the shape of the speaker diaphragm, and in this exemplary configuration, the net is formed in a corn shape. The net 43, for example, is formed of a plurality of holes, the material in the suspension containing the material of the diaphragm layer is deposited on the net 43, and the liquid is passed through the holes. As the net 43, for example, a wire net or a punching metal may be employed. The slope portion 44 is a barrel member (almost the cylindrical shape in the illustrated example) which is formed in an inclined shape (a tapered shape) such that the inner diameter of the inner peripheral surface is gradually reduced as it goes from an upper end 44a toward a lower end 44b. The edge portion of the lower end 44b of the slope portion 44 is connected to the outer peripheral portion 43a of the net 43 over the entire peripheral. The edge portion of the upper end 44a of the slope portion 44 is supported by the mounting portion 41 over the entire peripheral.

In the sheet-forming portion 40, a step portion 41C which is formed in the edge portion on a side near the upper end of the mounting portion 41 is detachably fitted to the lower end of the tank body 31. In addition, at this time, the tank body 31, the mounting portion 41, the mold 42, and the net 43 are disposed such that the axial centers thereof are overlapped on an axial line L.

The liquid injection portion 50 includes a liquid injection port 51 and a pipe 52. The liquid injection port 51 is opened in a slit shape (that is, an annular shape) over the entire peripheral in the inner peripheral surface 31a of the tank body 31 in the lower portion of the tank body 31 (that is, the lower portion of the tank 30). Therefore, it is possible to inject the liquid through the entire circumferential direction of the tank body 31 from the liquid injection port 51. The liquid injection port 51 may be at least provided in the lower portion of the tank 30, and in this exemplary configuration, as an example, the liquid injection port 51 is provided in a portion lower than the tank 30 and upper than the sheet-forming portion 40 (specifically, the upper end 44a of the slope portion 44). The pipe 52 is connected to the liquid injection port 51, and is configured to lead the liquid supplied from the liquid injection device 62 to the liquid injection port 51.

The dewatering device 61, for example, includes a suction pump, and is connected to the respective suction ports 42A of the mold 42. The dewatering device 61 sucks a fluid in the liquid contained in the tank body 31 through the net 43 provided in the lower portion of the tank 30. The dewatering device 61 is connected to the controller 70, and is operated according to a control signal from the controller 70.

The liquid injection device 62 includes a storage tank which contains the liquid to be injected to the tank 30 and a pump (not illustrated) which feeds out the liquid contained in the storage tank to the pipe 52 connected to the tank 30. The storage tank may be configured by one or more, or may store the liquid in the storage tank for each liquid different in type. The liquid injection device 62 is connected to the controller 70, and is operated according to the control signal from the controller 70.

The controller 70, for example, is configured by a micro-computer, and collectively controls the entire manufacturing apparatus 20 so as to realize the function according to the present invention. The controller 70 controls the operations of the dewatering device 61 and the liquid injection device 62. At this time, as illustrated in FIG. 2, the controller 70 performs the control based on a detection result of a sensor 32 provided in the tank 30. The sensor 32, for example, detects a characteristic related to the liquid or the material in the tank 30 such as a water level of the liquid, a degree of dispersion of the material in the liquid, and a degree of flow of the liquid, and outputs a signal indicating the detection result to the controller 70.

In addition, as described below, the tank 30 is desirably formed to have the tank body 31 of a previously-defined length or more such that the suspensions containing the material of the diaphragm layer are sequentially injected while the liquid layer containing no material of the diaphragm layer is interposed.

Next, an example of the manufacturing method of the speaker diaphragm using the manufacturing apparatus 20 will be described with reference to the drawings. In the manufacturing method, the water is employed as the fluid contained in the liquid used for the sheet-forming.

The manufacturing method of the speaker diaphragm includes (1) a diaphragm layer forming process and (2) a forming process. The diaphragm layer forming process includes (1-a) a first diaphragm layer forming process, (1-b) a liquid layer injection process, and (1-c) a second diaphragm layer forming process as sub processes.

### (1) Diaphragm Layer Forming Process

In the diaphragm layer forming process, a first suspension K1 and a second suspension K2 containing the material forming the respective diaphragm layers are sequentially injected into the tank 30, and the fluid in the tank 30 is dewatered. The first suspension K1 corresponds to an example of the first liquid, and the second suspension K2 corresponds to an example of the second liquid.

### (1-a) First Diaphragm Layer Forming Process

First, as illustrated in FIG. 2, the first suspension K1 containing the material 4a1 of the first diaphragm layer 4a is injected into the tank 30. At this time, the liquid injection device 62 is controlled by the controller 70, and the first suspension K1 is previously prepared by containing the material 4a1 in the water and is injected from the liquid injection port 51. In addition, the material 4a1 may be injected (input) into the tank 30 from the opening on the upper end of the tank 30 while injecting the fluid such as the water into the tank 30. The method of injecting the first suspension K1 into the tank 30 from the beginning is arbitrary. In the tank 30, the material 4a1 is dispersed into the water so as to form a first suspension layer R51. In the defined-shape net 43, the fluid (that is, the water) is passed through the net 43 and dewatered, and the material 4a1 is deposited onto the net 43. At this time, the dewatering device 61 may be controlled by the controller 70 to be dewatered by forcibly absorbing the fluid, or may be dewatered by naturally dropping the fluid without the forcible absorption. In the first diaphragm layer forming process, an injecting speed of the first suspension K1 or a dewatering speed of the fluid is appropriately adjusted such that the water level of the liquid in the tank 30 is not lower than the liquid injection port 51.

### (1-b) Liquid Layer Injection Process

After the material 4a1 of the first diaphragm layer 4a is injected into the tank 30, as illustrated in FIG. 3, the liquid injection device 62 is controlled by the controller 70 such that a predetermined amount of the fluid W (the water) is injected from the liquid injection port 51. At this time, the fluid W is injected in the liquid in the tank 30 in a state where the water level of the liquid in the tank 30 is higher than the liquid injection port 51. In addition, it is desirable to inject the fluid W at a speed to an extent that no disturbance (surface waviness) is generated in a liquid surface of the liquid in the tank 30. In the tank 30, a liquid layer R52 containing no material of the diaphragm layer is formed. A thickness (a length along a vertical direction of the tank 30) of the liquid layer R52 is desirably determined according to various conditions such as a specific gravity of the material of each diaphragm layer or a dropping speed of the material in the liquid. At this time, the dewatering device 61 may be controlled by the controller 70 to be dewatered by forcibly absorbing the fluid, or may be dewatered by naturally dropping the fluid without the forcible absorption. Even in the liquid layer injection process, an injection speed of the fluid W or a dewatering speed of the fluid is appropriately adjusted such that the water level of the tank 30 is not lower than the liquid injection port 51.

### (1-c) Second Diaphragm Layer Forming Process

After the fluid W is injected into the tank 30, as illustrated in FIG. 4, the second suspension K2 previously prepared by containing the material 4b1 in the water is injected into the tank 30 from the liquid injection port 51. At this time, the second suspension K2 is injected in the liquid in the tank 30 in a state where the water level of the tank 30 is higher than the liquid injection port 51. In addition, the second suspension K2 is desirably injected at a speed to an extent that no disturbance (surface waviness) is generated in the liquid surface of the liquid in the tank 30. In the tank 30, a second suspension layer R53 made by dispersing the material 4b1 in the water is formed. The fluid (that is, the water) is passed through the net 43 and dewatered, and the material 4b1 of the second diaphragm layer 4b is deposited so as to be overlapped on the material 4a1 of the first diaphragm layer 4a which is deposited on the net 43. At this time, the fluid may be forcibly absorbed by the dewatering device 61 for the dewatering, or may be dewatered by the natural dropping without the forcible absorption.

In addition, as illustrated in FIG. 5, after the second suspension K2 is injected, the liquid injection device 62 is controlled by the controller 70, and a predetermined amount of the fluid W is injected from the liquid injection port 51, so that a liquid layer R54 containing no material of the diaphragm layer may be formed.

Then, the liquid component (the water) in the tank 30 is dewatered, and a multi-layered sheet-forming body is obtained in which the material 4a1 of the first diaphragm layer 4a and the material 4b1 of the second diaphragm layer are stacked on the net 43.

In this exemplary configuration, in the diaphragm layer forming process, the liquid layer injection process is interposed between the first diaphragm layer forming process and the second diaphragm layer forming process. In other words, a predetermined period of time is provided between a time when the injection of the first suspension K1 performed in the first diaphragm layer forming process ends and a time when the injection of the second suspension K2 performed in the second diaphragm layer forming process starts, and the fluid W containing no material of each diaphragm layer in the liquid in the tank 30 is injected. In addition, by providing the predetermined period of time, the material 4a1 is precipitated after the injection of the first suspension K1 so as to be deposited on the net 43. In a case where the liquid layer R52 containing no material of the diaphragm layer is formed even when the fluid W is not injected, the liquid layer injection process of injecting the water W in the predetermined period of time may be eliminated.

In addition, in the above process, the controller 70 adjusts the injection timings, the injecting speeds, or the dewatering speeds of the first suspension K1, the second suspension K2, and the water W according to the states of the first suspension layer R51, the liquid layer R52, and the second suspension layer R53 in addition to a deposition (stacked layer) state on the net. However, the present invention is not limited to the above configuration and, for example, the dewatering device 61 and the liquid injection device 62 may be operated by manual while a worker confirms the states in the tank 30 by viewing instead of the controller 70.

In addition, in this exemplary configuration, since the sheet-forming portion 40 (specifically, the net 43) is provided in the lower portion of the tank 30 in the diaphragm layer forming process, the dewatering starts from a time point when the liquid is injected into the tank 30, and then goes on until a time point when the fluid in the tank 30 runs out. However, regarding the dewatering, the start timing and the continuation period of the dewatering in the diaphragm layer forming process are arbitrary as long as the material 4a1 contained in the first suspension K1 and the material 4b1 contained in the second suspension K2 are sequentially deposited on the net 43 and dewatered. In addition, since the material 4a1 contained in the first suspension K1 and the material 4b1 contained in the second suspension K2 are sequentially deposited, the start timing and the continuation period of the dewatering can be arbitrarily changed. For example, the dewatering may be continuously performed from after the injection of the first suspension K1 is completed (including a timing immediately after the injection is completed and a timing elapsed by a certain time from immediately after the injection is completed) until the injection of the second suspension is completed, or the dewatering may start before the injection of the second suspension starts at the latest.

### (2) Forming Process

In the above-mentioned diaphragm layer forming process, a multi-layered sheet-forming body (that is, a precursor of the speaker diaphragm 4) obtained by stacking the material 4a1 of the first diaphragm layer 4a and the material 4b1 of the second diaphragm layer which are formed on the net 43 is formed by a method such as a hot pressing, a wet pressing, or an oven method, and the speaker diaphragm 4 is manufactured as illustrated in FIGS. 1B and 1C. Specifically, the multi-layered sheet-forming body is detached from the net 43, and for example, as illustrated in FIG. 6, is heated and pressed using a mold 80 which includes a female mold 81 provided with a heating portion 811 and a male mold 82 provided with a heating portion 821, and the speaker diaphragm 4 having a predetermined shape is manufactured.

In addition, the multi-layered sheet-forming body is detached from the net 43, and for example, as illustrated in FIG. 7, the multi-layered sheet-forming body is disposed in a mold 83 having a hollow portion 831 disposed in a drying pot 800, and dried by a heating device 84 such as a gas heater disposed above the mold 83 while being absorbed by a vacuum pump 832. In this method, the speaker diaphragm 4 is manufactured only by the drying without the pressing.

Next, a specific example of the manufacturing method of the two-layered speaker diaphragm will be described.

An NBKP (Nadelholz Bleached Kraft Pulp) of the wood pulp fiber is employed as the material 4a1 of a base layer (the first diaphragm layer 4a). First, the NBKP of the wood pulp fiber is beaten and dispersed in the water of which the beating degree is set to about 20° SR (Schopper Riegler) so as to manufacture a suspension (the first suspension K1) having a concentration of about 1.0 g/L. As illustrated in FIG. 2, the first suspension K1 is injected into the tank 30 from the liquid injection port 51. The material 4a1 starts to be settled by the weight of the material 4a1 after the injection, and then starts to be sucked by the dewatering device 61 from the suction port 42A of the mold 42 so as to be dewatered, so that the material 4a1 is deposited on the net 43 having a predetermined shape. After the injection of the first suspension K1, the water W is continuously injected from the liquid injection port 51 to the liquid in the tank 30, and as illustrated in FIG. 3, the liquid layer R52 containing no material of the diaphragm layer is formed. During the above process, the dewatering is continuously performed.

Next, the NBKP (Nadelholz Bleached Kraft Pulp) is employed as the material 4b1 of the surface layer (the second diaphragm layer 4b), the NBKP is dispersed in the water (the fluid having a raw material of which the beating degree is adjusted to be about 20° SR) so as to manufacture a suspension (the second suspension K2) having a concentration of about 1.0 g/L. After the injection of the water W, as illustrated in FIG. 4, the second suspension K2 is injected in the liquid in the tank 30 from the liquid injection port 51. At this time, the suction is continuously performed by the dewatering device 61, and the material 4b1 is deposited on the net 43. The strength of the suction at this time is necessarily kept in a balance with the supply amount of the water. The dewatering device 61 according to this exemplary configuration is configured to be adjusted in its vacuum degree within a range from about 0 to 500 mmHg (0 to 66660 Pa). As illustrated in FIG. 6, when the tank body 31 is removed from the sheet-forming portion 40 and the net 43 is placed on the mold 80 having the same shape and sucked, the deposited material moves onto the mold 80. At this time, the mold 80 is heated to a temperature of about 160° C., pressed under a pressure of about 2 kg/cm² (196 kPa) for 40 seconds, and then dried. In addition, in the above-mentioned example, the first diaphragm layer 4a and the second diaphragm layer 4b may be dyed with colors different from each other.

As described above, the speaker diaphragm 4 of this embodiment includes the first diaphragm layer 4a and the second diaphragm layer 4b which are respectively configured by the sheet-forming bodies of the materials 4a1 and 4b1 and stacked to each other, and the first diaphragm layer 4a and the second diaphragm layer 4b are integrally formed in the boundary portion. With such a configuration, the connectivity between the respective layers can be increased without using an adhesive fiber, and the interlayer separation can be suppressed at a low cost. Further, the adhesive fiber such as polyvinylalcohol fiber, polyvinylalcohol fiber containing boron, or thermally fusible fiber may be used for the purpose of the adjustment of a physical property of the speaker diaphragm.

In addition, the materials contained in the first diaphragm layer 4a and the second diaphragm layer 4b are entangled with each other in the boundary portion between the first diaphragm layer 4a and the second diaphragm layer 4b so as to form the entangled portion 4z . Therefore, the first diaphragm layer 4a and the second diaphragm layer 4b are integrated in the entangled portion in the boundary portion, and the integrity between the respective layers is increased, so that the interlayer separation can be suppressed.

In addition, since the thickness of the entangled portion 4z is smaller than that of the first diaphragm layer 4a or the second diaphragm layer 4b, the integrity between the first diaphragm layer 4a and the second diaphragm layer 4b is increased, so that the separation between the first diaphragm layer 4a and the second diaphragm layer 4b can be suppressed. In addition, since the integrity of the first diaphragm layer 4a and the second diaphragm layer 4b is increased while keeping the predetermined thickness of the first diaphragm layer 4a and the second diaphragm layer 4b, the separation between the first diaphragm layer 4a and the second diaphragm layer 4b can be suppressed. In addition, since the predetermined thickness of the first diaphragm layer 4a and the second diaphragm layer 4b can be kept, the acoustic characteristic of the speaker device using the speaker diaphragm according to the present invention can be improved.

In addition, the first diaphragm layer 4a and the second diaphragm layer 4b have a peeling strength therebetween. Therefore, the interlayer separation can be suppressed by increasing the integrity between the layers.

In addition, in a case where the second diaphragm layer 4b is the surface layer, the second diaphragm layer 4b is formed to have a uniform thickness over the entire area. In a case where the thickness of the second diaphragm layer 4b is not uniform and a thickness at a predetermined position becomes very small, a desire physical characteristic of the speaker diaphragm 4 is not obtained. Therefore, the acoustic characteristic of the speaker device is reduced. However, since the second diaphragm layer 4b of the speaker diaphragm 4 according to the present invention has a uniform thickness, a desired physical characteristic of the speaker diaphragm 4 is obtained, so that the acoustic characteristic of the speaker device can be improved, and a desired acoustic characteristic can be obtained.

In addition, the first diaphragm layer 4a adjacent to the second diaphragm layer 4b has a uniform thickness over the entire area. In a case where the thickness of the first diaphragm layer 4a is not uniform and a thickness at a predetermined position becomes very small, a desired physical characteristic of the speaker diaphragm 4 is not obtained. Therefore, the acoustic characteristic of the speaker device is reduced. However, since the first diaphragm layer 4a of the speaker diaphragm 4 according to the present invention has a uniform thickness, a desired physical characteristic of the speaker diaphragm 4 is obtained, so that the acoustic characteristic of the speaker device can be improved, and a desired acoustic characteristic can be obtained.

Hitherto, the present invention has been described using the preferred embodiment, but the present invention is not limited to the configuration of the embodiment.

For example, the above-mentioned speaker diaphragm may be configured such that the first diaphragm layer 4a is the surface layer. In addition, the speaker diaphragm 4 may be configured by a multi-layer structure having three or more layers. In this case, at least a third diaphragm layer 4c is provided. Even in the third diaphragm layer 4c, since the first diaphragm layer 4a and the second diaphragm layer 4b have a uniform thickness, a desired physical characteristic of the speaker diaphragm 4 is obtained, so that the acoustic characteristic of the speaker device can be improved, and a desired acoustic characteristic can be obtained.

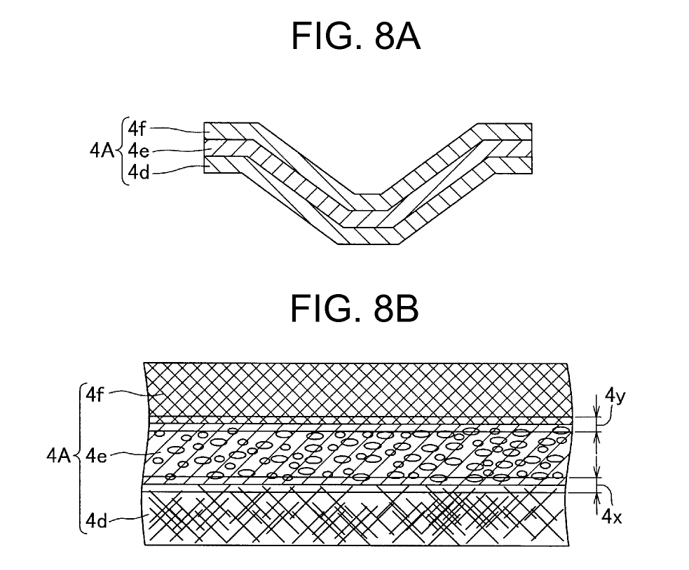

In addition, for example, the manufacturing method of the above-mentioned speaker diaphragm is a method of manufacturing the two-layered speaker diaphragm 4, but the present invention is not limited thereto. The manufacturing method may be a method of manufacturing a speaker diaphragm 4A of a multi-layer structure having three or more layers illustrated in FIGS. 8A and 8B. The speaker diaphragm 4A has a three-layer structure in which the first diaphragm layer 4d, a second diaphragm layer 4e, and a third diaphragm layer 4f are sequentially stacked. A foam layer is formed as the second diaphragm layer 4e serving as an intermediate layer. The foam layer is manufactured such that a fine hollow body (a foaming material having a hollow particle shape) extendable when being heated is sheet-formed and then heated and compressed.

A manufacturing method of the speaker diaphragm 4A having the three-layer structure will be simply described. (1) The suspension (the first suspension) containing the material of the first diaphragm layer 4d is injected in the tank 30. (2) The water (the fluid) containing no material of the diaphragm is injected in the liquid in the tank 30 from the liquid injection port 51. At this time, the liquid layer made of the water is overlapped and formed on the suspension layer made of the first suspension. (3) In the liquid in the tank 30, the suspension (the second suspension) containing a fine hollow body (a foaming material having a hollow particle shape) extendable when being heated as a material of the second diaphragm layer 4e is injected from the liquid injection port 51. At this time, the suspension layer made of the second suspension is overlapped and formed on the liquid layer. (4) The water (the fluid) containing no material of the diaphragm is injected in the liquid in the tank 30 from the liquid injection port 51. At this time, the liquid layer made of the water is overlapped and formed on the suspension layer made of the second suspension. (5) The suspension (a third suspension) containing the material of the third diaphragm layer 4f is injected in the liquid in the tank 30. At this time, the suspension layer made of the third suspension is overlapped and formed on the liquid layer. Then, the fluid in the tank 30 is discharged through the dewatering performed in parallel with the injection of the liquid, and the multi-layered sheet-forming body is obtained in which the first diaphragm layer 4d, the second diaphragm layer 4e, and the third diaphragm layer 4f are stacked on the net 43. As illustrated in FIG. 6, the multi-layered sheet-forming body is heated and compressed by the mold 80 similarly to the above embodiment, and the speaker diaphragm 4A having the three-layer structure is manufactured as illustrated in FIGS. 8A and 8B.

Next, a specific example of the manufacturing method of the speaker diaphragm having the three-layer structure will be described.

As a material of a base layer (the first diaphragm layer 4d), the pulp fiber of which the NBKP is prepared to 20° SR similarly to the first embodiment is used, and a cationic sizing agent is further added to the pulp material by about 5% in order to increase a waterproof property. As a material of the intermediate layer (the second diaphragm layer 4e), for example, a fine hollow body which has a mean particle diameter of about 20 μm and is extendable when being heated is dispersed into the water (the fluid) at a concentration of about 1.0 g/L so as to manufacture a turbid liquid (a second turbid liquid). As a material of the surface layer (the third diaphragm layer 4f), a raw material mixed with mica powder at a rate of 10% is mixed with the same pulp raw material (90%) as that of the base layer (the first diaphragm layer 4d) so as to be prepared to be a concentration of about 1.0 g/L, and the sizing agent is added at about 5%, and thus a turbid liquid (a third turbid liquid) is manufactured.

First, the material of the base layer and the water are injected into the tank 30 to manufacture a turbid liquid (a first turbid liquid). Then, after the water is injected in the liquid in the tank 30 from the liquid injection port 51, the second turbid liquid is injected in the liquid in the tank 30 from the liquid injection port 51. Further after the water is injected in the liquid in the tank 30 from the liquid injection port 51, the third turbid liquid is injected in the liquid in the tank 30 from the liquid injection port 51. In the sheet-forming portion 40, the fluid in the tank 30 is dewatered in parallel with the injection of each liquid, and the multi-layered sheet-forming body made of the first diaphragm layer 4d, the second diaphragm layer 4e, and the third diaphragm layer 4f is obtained on the net 43. Then, the multi-layered sheet-forming body is pressed and dried similarly to the first embodiment by the mold 80 which is heated to about 160° C. When being heated, the fine hollow body is expended, and as illustrated in FIG. 8(b), the speaker diaphragm 4A is completed in which the foam layer is formed in the second diaphragm layer 4e.

In the speaker diaphragm 4A, a first entangled portion 4x, where the material of the first diaphragm layer 4d and the material of the second diaphragm layer 4e are entangled, is formed in the boundary portion between the first diaphragm layer 4d and the second diaphragm layer 4e. In addition, a second entangled portion 4y, where the material of the second diaphragm layer 4e and the material of the third diaphragm layer 4f are entangled, is formed in the boundary portion between the second diaphragm layer 4e and the third diaphragm layer 4f. The thickness of the first entangled portion 4x is smaller than that of the first diaphragm layer 4d, the second diaphragm layer 4e, or the third diaphragm layer 4f. Similarly, the thickness of the second entangled portion 4y is smaller than that of the first diaphragm layer 4d, the second diaphragm layer 4e, or the third diaphragm layer 4f.

In addition, in the speaker diaphragm 4, the first diaphragm layer 4d, the second diaphragm layer 4e, and the third diaphragm layer 4f are integrated with each other. The speaker diaphragm has a peeling strength as high as the peeling of the first diaphragm layer 4d, the second diaphragm layer 4e, or the third diaphragm layer 4f is difficult.

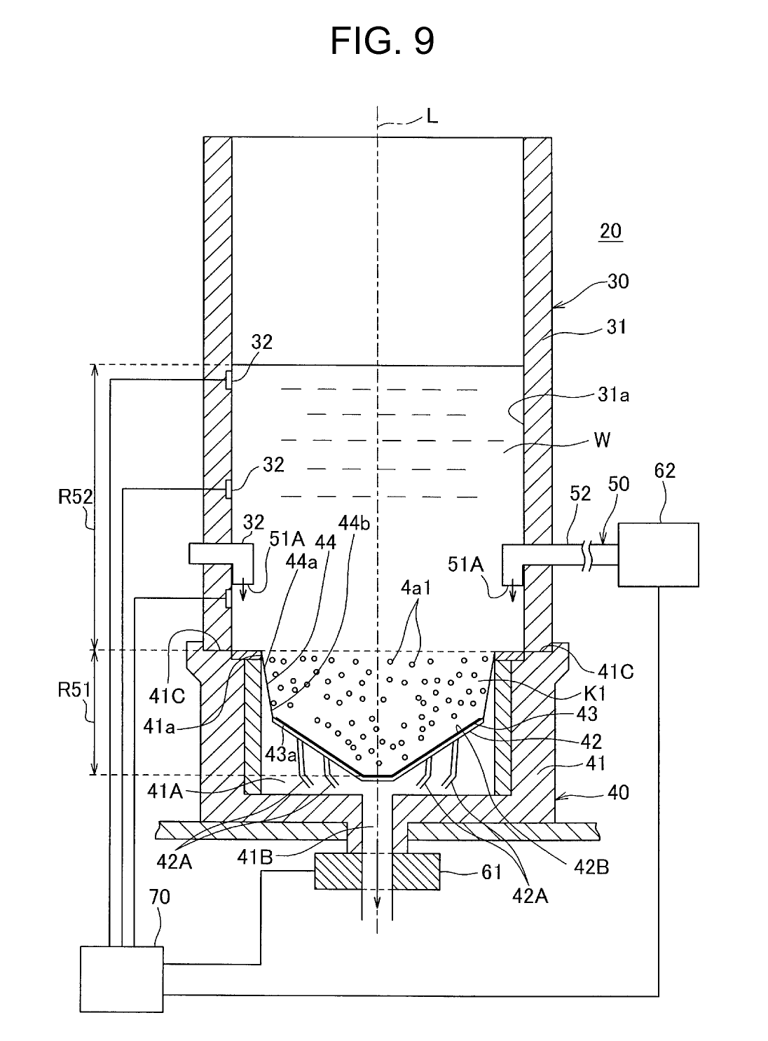

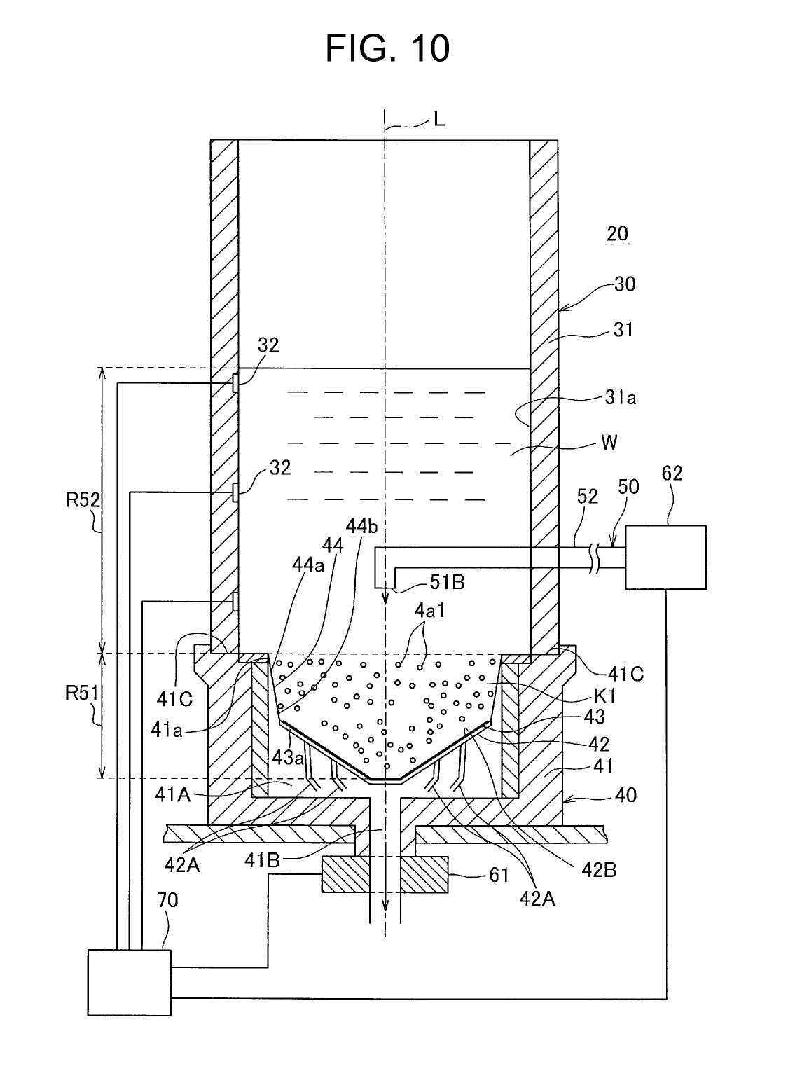

In addition, in the manufacturing apparatus 20 of the above-mentioned speaker diaphragm, the liquid injection port 51 is disposed in the lower portion of the tank 30 and above the sheet-forming portion 40 (specifically, the upper end 44a of the slope portion 44) and opened in a horizontal direction, but as a matter of course, the present invention is not limited thereto. For example, as a liquid injection port 51A illustrated in FIG. 9, the liquid injection port may be formed to be disposed in the inner peripheral surface of the tank body 31 in a circumferential direction and opened in a downward direction. Alternatively, as a liquid injection port 51B of the pipe 52 illustrated in FIG. 10, the liquid injection port may be formed such that the pipe 52 is extended up to the center portion of the tank body 31 and opened in the horizontal direction, the vertical direction, or the upward direction. In other words, the direction of opening the liquid injection port 51 is not limited to the horizontal direction, the downward direction, or the upward direction, and can be arbitrarily set as long as the fluid can be injected in the liquid in the tank 30, while not being inconsistent with the purpose of the present invention.

In addition, in the manufacturing apparatus 20 of the above-mentioned speaker diaphragm, the first suspension K1 corresponds to an example of the first liquid, and the second suspension K2 corresponds to an example of the second liquid. Herein, the first liquid and the second liquid mean that the first liquid is firstly injected and the second liquid is injected after the first liquid, that is, the “first” and the “second” simply means only a relative relation indicating a sequence but not an absolute relation of the sequence. In other words, it does not means that the first liquid is injected at the first among all the liquids, and the second liquid is injected at the second among all the liquids. For example, in a case where four types of liquids are sequentially injected, when paying attention to the second injection liquid and the third injection liquid, the former one corresponds to an example of the first liquid, and the latter one corresponds to an example of the second liquid. Similarly, even when paying attention to the third injection liquid and the fourth injection liquid, the former one corresponds to an example of the first liquid, and the latter one corresponds to an example of the second liquid.

Further, the above-mentioned embodiment is a mere example representing the present invention, but the present invention is not limited to the embodiment. In other words, a person skilled in the art can implement various modifications according to the conventional knowledge in a scope not departing from the gist of the present invention. As a matter of course, any modifications and changes provided with the configuration of the speaker diaphragm of the present invention belong to the category of the present invention.

### (Verification)

As the speaker diaphragm, the following speaker diaphragms of first and second examples and a first comparative example were manufactured, and the physical values of the respective speaker diaphragms were measured and compared.

### FIRST EXAMPLE

The speaker diaphragm of the first example was manufactured using the manufacturing method of the above-mentioned speaker diaphragm, in which the first diaphragm layer configured by the NBKP of the wood pulp fiber having a beating degree of 20° SR and the second diaphragm layer configured by the NBKP of the wood pulp fiber having the same beating degree of 20° SR were included. The density of the first diaphragm layer was higher than that of the second diaphragm layer. The first diaphragm layer and the second diaphragm layer were integrated in the boundary portion.

### SECOND EXAMPLE

The speaker diaphragm of the second example was manufactured using the manufacturing method of the above-mentioned speaker diaphragm, in which the first diaphragm layer configured by the NBKP of the wood pulp fiber having a beating degree of 20° SR, the second diaphragm layer configured by the NBKP of the wood pulp fiber having a beating degree of 20° SR, and a fabric body disposed between the first diaphragm layer and the second diaphragm layer were included. The fabric body was configured by a polypropylene fiber. The first diaphragm layer and the fabric body, and the second diaphragm layer and the fabric body were integrated in each boundary portion.

### FIRST COMPARATIVE EXAMPLE

The speaker diaphragm of the first comparative example was configured to include a single diaphragm layer configured by the NBKP of the wood pulp fiber having a beating degree of 20° SR.

Table 1 lists measurement results of the physical values of the speaker diaphragms of the first and second examples and the first comparative example.

TABLE 1

| | | Weight | | | | | | Loss |
|---|---|---|---|---|---|---|---|---|
| | | per | | | Young's | | Propagation | Elastic |
| | | Unit | | Specific | Modulus | Internal | Speed | Modulus |
| | Thickness | Area | Density | Volume | E × 10⁹ | Loss | √E/ρ | E″ × 10⁷ |
| | mm | g/m² | g/cm³ | cm³/g | N/m² | ×10⁻² | ×10⁵ | N/m² |
| First | 0.476 | 357 | 0.750 | 1.33 | 3.06 | 3.95 | 2.01 | 12.08 |
| Example | | | | | | | | |
| Second | 0.517 | 349 | 0.708 | 1.85 | 4.18 | 4.09 | 2.43 | 8.73 |
| Example | | | | | | | | |
| First | 0.806 | 341 | 0.423 | 2.37 | 1.26 | 4.26 | 1.74 | 5.38 |
| Comparative | | | | | | | | |
| Example | | | | | | | | |

As can be seen from the above measurement results, Young's moduli of the speaker diaphragms of the first and second examples are larger than that of the speaker diaphragm of the first comparative example. In addition, propagation speeds of the speaker diaphragms of the first and second examples are larger than that of the speaker diaphragm of the first comparative example. In addition, internal losses of the speaker diaphragms of the first and second examples are slightly smaller than or substantially equal to that of the speaker diaphragm of the first comparative example.

In general, the Young's modulus and the internal loss of the speaker diaphragm are inversely proportional to each other, and in a case where one of the Young's modulus and the internal loss is larger, the other one becomes small. However, the speaker diaphragms of the first and second examples are formed by integrating a first diaphragm and a second diaphragm directly or with a fabric body interposed therebetween, so that the internal loss may be improved by friction between the material of the first diaphragm and the material of the second diaphragm. In addition, the entangled portion is formed in the boundary between the first diaphragm and the second diaphragm, so that the friction easily occurs. Therefore, the internal loss may be improved.

In addition, since the densities of the speaker diaphragms of the first and second examples are larger than that of the speaker diaphragm of the first comparative example, the Young's modulus of the speaker diaphragm may be improved. As a factor causing the large densities of the speaker diaphragms of the first and second examples, it may be considered that the dewatering time is relatively long so that the material is pulled toward the net to make the space in the diaphragm layer relatively smaller. On the other hand, in a case where the density of the first diaphragm layer is large, the material of the second diaphragm layer is hard to enter the inside of the first diaphragm layer so that the second diaphragm layer can be formed to have a predetermined or uniform thickness on the first diaphragm layer.

In addition, in the speaker diaphragms of the first and second examples, the first diaphragm layer and the second diaphragm layer are integrated. The speaker diaphragms have a peeling strength as high as the peeling of the first diaphragm and the second diaphragm is difficult.

In addition, in the speaker diaphragms of the first and second examples, the entangled portion is formed in the boundary between the first diaphragm layer and the second diaphragm. In the entangled portion, the fiber of the first diaphragm layer and the fiber of the second diaphragm layer are entangled. Therefore, the fiber in the entangled portion may permeate from the first diaphragm layer toward the second diaphragm layer in a case where the sheet-forming is made in a sequence of the first diaphragm layer and the second diaphragm layer, or may permeate from the second diaphragm layer toward the first diaphragm layer in a case where the sheet-forming is made in a sequence of the second diaphragm layer and the first diaphragm layer. In addition, the fiber in the layer other than the entangled portion is deposited along the front or rear surface or the boundary of the speaker diaphragm. Therefore, a direction where the fiber in the entangled portion is deposited may be different from a direction where the fiber in a portion other than the entangled portion is deposited. In addition, the entangled portion may be formed over the entire boundary between the first diaphragm layer and the second diaphragm, or may be formed only at a predetermined position in the boundary.

The speaker diaphragms of the first and second examples are different from the comparative example in that the boundary portion is provided, the entangled portion is provided, and the direction of depositing the fiber in the entangled portion is different. Besides, in a case where the sheet-forming is made in a sequence of the first diaphragm layer and the second diaphragm layer, the density of the first diaphragm layer may be larger than that of the second diaphragm, or in a case where the sheet-forming is made in a sequence of the second diaphragm layer and the first diaphragm layer, the density of the second diaphragm layer may be larger than that of the first diaphragm layer. Therefore, the densities of the entire speaker diaphragms of the first and second examples may be different compared to the comparative example. In addition, with the difference in the density, the Young's moduli and the propagation speeds of the speaker diaphragms in the first and second examples may be larger compared to the comparative example. Hitherto, the description has been made about the first and second examples and the comparative example, and the present embodiment does not necessarily have all the differences but may have at least one of the differences.

### REFERENCE SIGNS LIST

4, 4A Speaker diaphragm
4a1, 4b1 Material (an example of material)
4a, 4d First diaphragm layer (an example of sheet-forming body)
4b, 4e Second diaphragm layer (an example of sheet-forming body)
4f Third diaphragm layer (an example of sheet-forming body)
4x First entangled portion
4y Second entangled portion
4z Entangled portion
10 Speaker device
20 Manufacturing apparatus of speaker diaphragm
30 Tank
31 Tank body
32 Sensor
40 Sheet-forming portion
41 Mounting portion
41B Connection port (an example of drain port)
42 Mold
43 Net
44 Slope portion
50 Liquid injection portion
51, 51A, 51B Liquid injection port
52 Pipe
61 Dewatering device
62 Liquid injection device
70 Controller
K1 First suspension
K2 Second suspension

1. A speaker diaphragm comprising:
a plurality of sheet-forming bodies configured to be stacked,
wherein two sheet-forming bodies adjacent to each other are integrated, and these integrated two sheet-forming bodies are peelable to be two sheet-forming bodies, and
wherein an entangled portion is provided over the entire boundary between the adjacent two sheet-forming bodies.

2. The speaker diaphragm according to claim 1,
wherein the entangled portion is formed by entangling fiber of one sheet-forming body permeating another sheet-forming body with fiber of the another sheet-forming body.

3. The speaker diaphragm according to claim 2,
wherein a thickness of the entangled portion is smaller than a thickness of one sheet-forming body of the two sheet-forming bodies.

4. The speaker diaphragm according to claim 2,
wherein a peeling strength is provided between the two sheet-forming bodies.

5. The speaker diaphragm according to claim 4,
wherein a space of the another sheet-forming body is smaller than a space of the one sheet-forming body.

6. The speaker diaphragm according to claim 5,
wherein a direction of the fiber in the boundary other than the entangled portion is a direction along the boundary, and a direction of the fiber in the entangled portion is a direction from the another sheet-forming body to the one sheet-forming body.

7. The speaker diaphragm according to claim 6,
wherein a Young's modulus of the another sheet-forming body is larger than a Young's modulus of the one sheet-forming body.

8. The speaker diaphragm according to claim 6,
wherein the one sheet-forming body is a surface layer in the plurality of sheet-forming bodies, and
the one sheet-forming body has a uniform thickness over the entire area.

9. The speaker diaphragm according to claim 8,
wherein the another sheet-forming body adjacent to the one sheet-forming body has a uniform thickness over the entire area.
